(19) United States
(12) Patent Application Publication
(10) Pub. No.: US 2012/0213030 A1
(43) Pub. Date: Aug. 23, 2012

(54) MIXER FOR USE IN A MICROWAVE OVEN

(75) Inventor: Chun Ming Cheung, Hong Kong (HK)

(73) Assignee: Licotec Industrial Limited, Hong Kong (HK)

(21) Appl. No.: 13/403,220

(22) Filed: Feb. 23, 2012

(30) Foreign Application Priority Data
Feb. 23, 2011 (GB) 1103081.4

(51) Int. Cl. B01F 9/10

(52) U.S. Cl. 366/204

(57) ABSTRACT

A microwave oven food mixer comprises a body including a drive mechanism and a plurality of adjustable arms extending outwardly from the body. The body and arms are configured so that the body may engage the lip of a culinary vessel disposed on a turntable of a microwave oven, with the arms extended to engage walls of the oven. A mixing arrangement extends downwardly from the body and is arranged to be located in said vessel during use. The mixing arrangement includes a fixed stirrer and a rotatable stirrer. The fixed stirrer is secured to the body and arranged to pass adjacent an inner wall of the vessel. The rotatable stirrer is connected to the drive mechanism and arranged so that rotation of the vessel on the turntable with the arms engaging walls of the oven causes rotation of the rotatable stirrer.

### CROSS REFERENCE TO RELATED APPLICATION

Applicant hereby claims foreign priority benefits under U.S.C. §119 from Great Britain Patent Application No. 1103081.4 filed on Feb. 23, 2011, the contents of which are incorporated by reference herein.

### TECHNICAL FIELD

This invention relates to a mixer, particularly but not exclusively for use in a microwave oven provided with a rotatable turntable.

### BACKGROUND OF THE INVENTION

A problem with heating of bowls of food in a microwave oven has been a lack of penetration of the microwave radiation into the bulk of the food, making it necessary to stop heating and manually stir the food one or more times to ensure thorough heating. For example, it is common to heat a bowl of food for two minutes, remove the bowl from the oven, stir the food and replace it in the oven for a further two minutes heating, followed if necessary by a repeat cycle of stirring and heating for two minutes. This is inconvenient and leads to a longer overall cooking time.

### SUMMARY OF THE INVENTION

According to the present invention there is provided a microwave oven food mixer comprising:
a body;
a plurality of arms extending outwardly from the body;
the length of each arm being adjustable between a retracted position and an extended position;
the body including a drive mechanism;
the body and arms being configured so that the body may be engaged to the lip of a culinary vessel disposed on a turntable of a microwave oven, with the arms extended to engage walls of the oven;
a mixing arrangement extending downwardly from the body and arranged to be located in said vessel in use;
wherein the mixing arrangement includes a fixed stirrer and a rotatable stirrer;
the fixed stirrer being secured to the body and being arranged to pass adjacent an inner wall of the vessel;
the rotatable stirrer being connected to the drive mechanism and arranged so that rotation of the vessel on a turntable in use with the arms engaging walls of the oven causes rotation of the rotatable stirrer.

A mixer in accordance with the present invention confers several advantages. The fixed stirrer is held immobile while the bowl is rotated by the rotating turntable of the microwave oven. This causes the contents of the vessel to be mixed. However, an axial vortex of unmixed foodstuff may be formed so that complete mixing of the body of the foodstuff is not achieved. This is particularly undesirable for foodstuffs which are heated in a microwave oven from a frozen or chilled state and which require thorough heating in order to sterilise any micro-organisms which may be present. Use of the rotatable stirrer of this invention increases the efficiency and thoroughness of mixing so that an axial vortex is not created. More thorough mixing is achieved so that the required heating time is reduced.

Preferably the fixed stirrer is a laminar member. Slots may be provided in the member to reduce drag during mixing. The member is preferably planar, but may be curved in plan view.

The fixed stirrer may be arranged to pass adjacent an inner wall of the vessel during rotation. The stirrer may act as a scraper to ensure circulation of the foodstuff in contact with or adjacent to the vessel wall. The scraper may have a flexible edge to improve contact with the vessel wall or base.

In preferred embodiments, the fixed stirrer extends radially from an inner location adjacent the axis of the mixer or spaced from the axis of the mixer to an outer location adjacent the interior wall of the vessel.

The rotatable stirrer may comprise a laminar member arranged to rotate about a stirrer axis. The stirrer may comprise a paddle and may be provided with one or more slots to reduce drag during use. A laminar member is preferred for ease of cleaning.

Preferably the stirrer axis is located at a distance from the mixer axis equal to a distance between the radii of the inner and outer locations of the fixed stirrer.

Preferably the rotatable stirrer is located at an angular disposition relative to the fixed stirrer of about 10° to about 130°, preferably from about 45° to about 120°, more preferably about 80° to 100°, especially about 90°.

The relative locations of the rotatable stirrer and fixed stirrer may be selected dependent on the speed of rotation of the mixer in use.

Preferably the radius of the rotatable stirrer and angular location relative to the fixed stirrer are selected so that an edge of the rotatable stirrer passes adjacent a surface of the fixed stirrer as the mixer rotates.

In preferred embodiments sufficient clearance is provided between the stirrers to prevent them from becoming blocked by particles or pieces of solid food.

Preferably the rotatable stirrer is located behind the fixed stirrer relative to the direction of flow of the foodstuff in use.

Preferably the mixer comprises a vessel engaging portion rotatably mounted on a fixed body, the arms being mounted on the fixed body.

Preferably the vessel engaging portion includes a rim arranged to engage the lip of the vessel. The vessel engaging portion may also include or comprise a cover to close the vessel during mixing. The rim may be formed from a high friction material, for example rubber or elastomer. A snap fastener may be provided. One or more releasable clips may also be provided.

Preferably the drive comprises a planetary gear arrangement. An orbital gear may be provided on the rotatable vessel engaging portion or cover, the orbital gear engaging a planetary gear which is connected to the rotatable stirrer. Rotation of the vessel engaging portion relative to the body and arms causes rotation of the rotatable stirrer. The speed of rotation of the rotatable stirrer is controlled by the gear ratio between the orbital and planetary gears. An orbital gear to planetary gear ratio of about 7:1 to 3:1, preferably about 5:1 may be conveniently employed.

In a preferred embodiment, the orbital gear is provided on an upper surface or lower surface of the cover. In such an embodiment the cover may be a circular flat configuration. This simple and robust arrangement provides a construction which is easy to clean and which may be manufactured from glass, rigid polymeric material or composite materials. For example, a disc like cover may be provided.

In preferred embodiments the mixer includes a mixing vessel dimensioned to co-operate with the rim and paddles in use. The vessel may be a mixing or serving bowl.

The arms may be mounted in guides in the body and arranged to be moveable between retracted and extended positions. Each arm may have a toothed rack with a gear being located within the body between the racks and engaging each rack so that the arms move simultaneously in opposite directions.

The handles on the ends of the arms may be rounded or cushioned to engage walls of the microwave oven. Suckers may be provided on the ends of the arms to improve contact with the oven walls. Preferably the arms have a length sufficient to extend into opposite corners of the oven.

The invention may further provide a kit comprising a mixer and one or more bowls. A series of fixed and rotatable stirrers may also be provided. A range of stirrers may be differently configured to facilitate efficient mixing of foodstuffs of different viscosities and solids' densities.

### BRIEF DESCRIPTION OF THE DRAWINGS

The invention is further described by means of example but not in any limitative sense with reference to the accompanying drawings, of which:

FIG. 1 is a perspective view of a mixer and bowl in accordance with this invention;

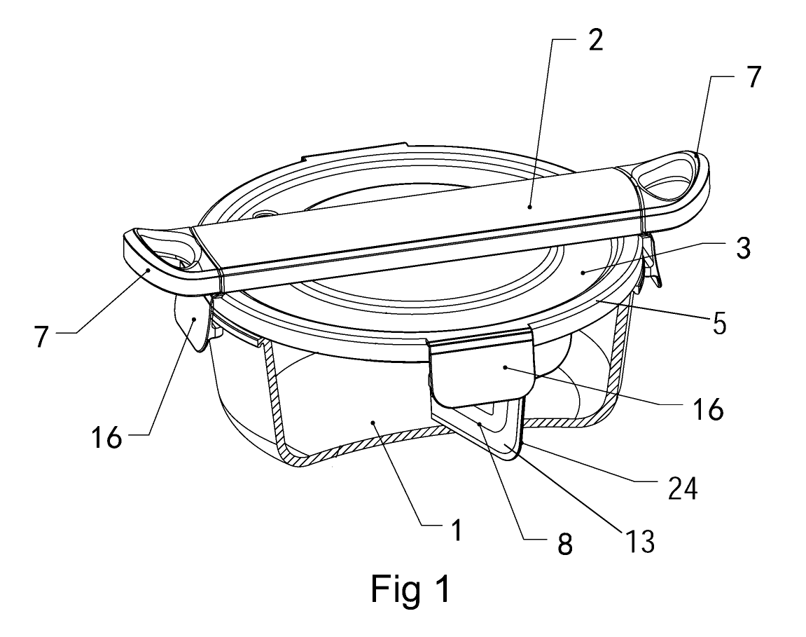

FIG. 2 is an exploded view showing components of the mixer;

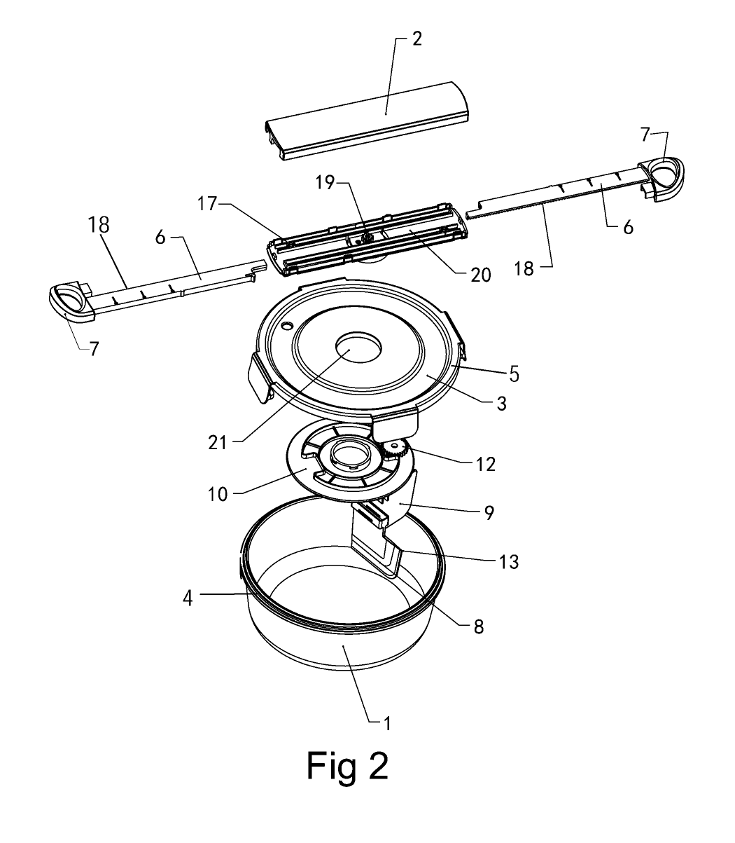

FIG. 3 is a further exploded view showing components of the mixer;

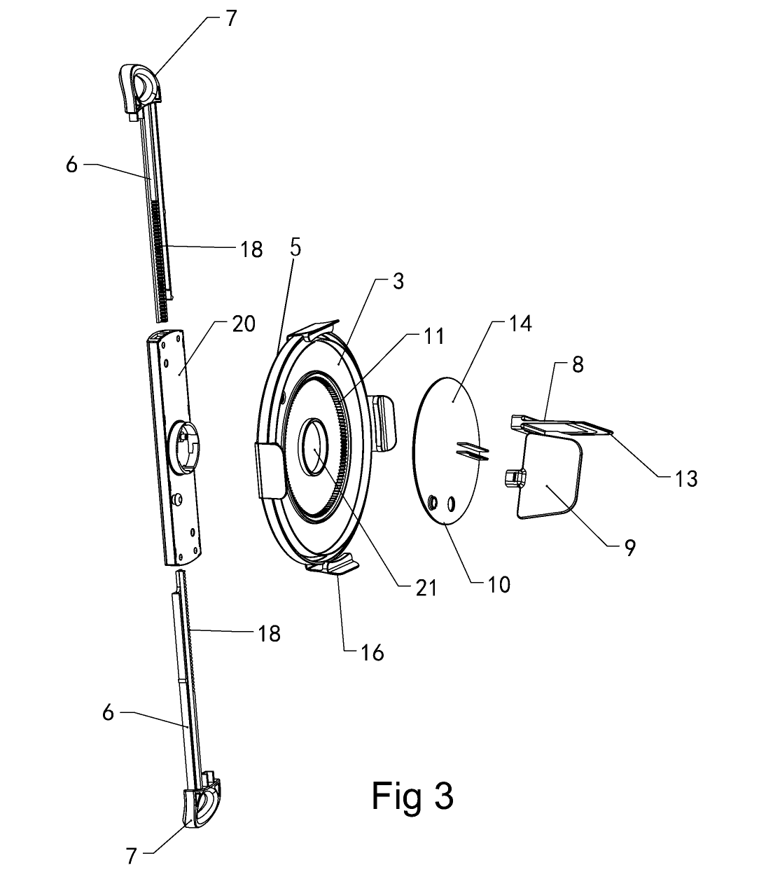

FIG. 4 is a view of the underside of the mixer;

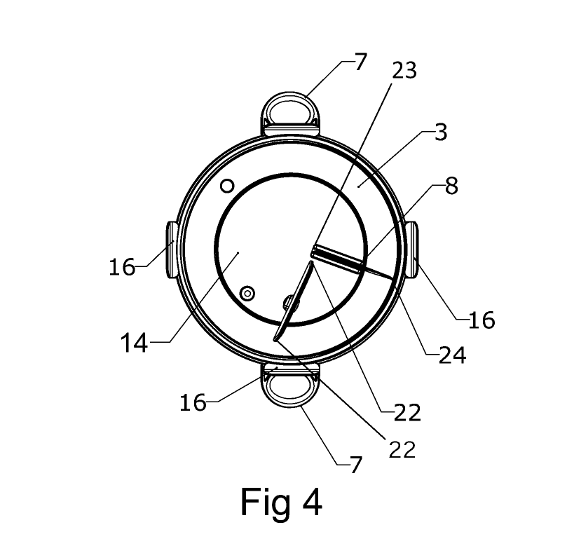

FIG. 5 is a view of the underside of the mixer showing the drive mechanism;

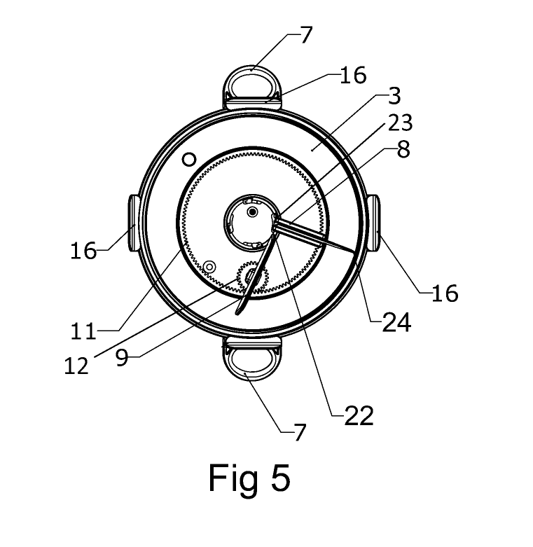

FIG. 6 shows the arms and body of the mixer; and

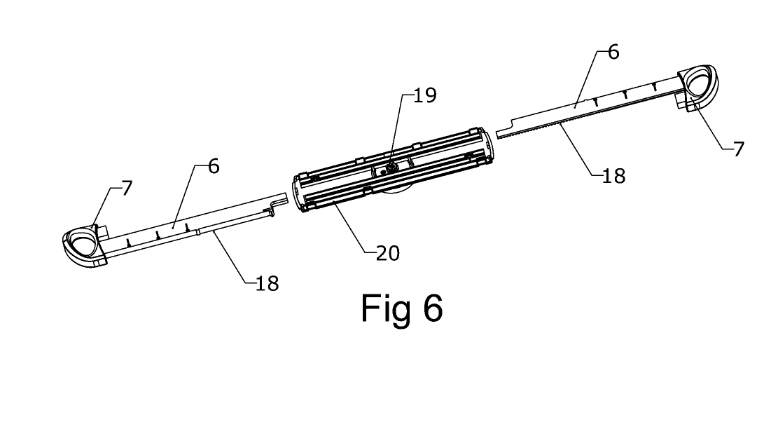

FIG. 7 is a perspective view illustrating the drive mechanism.

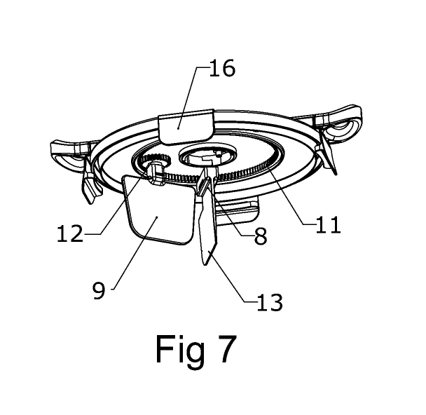

### DETAILED DESCRIPTION OF THE PREFERRED EMBODIMENTS

A mixer in accordance with this invention is illustrated in the following drawings. Like reference numerals are used to denote the same parts in each drawing. The arrangement shown in the drawings comprises a bowl (1) dimensioned to be received on the turntable of a domestic microwave oven (not shown). A body (2) is mounted on a cover. The cover (3) has a rim (5) arranged to engage the lip (4) of the bowl (1). The body (2) includes two guides (17) along which the arms (6) may slide between extended and retracted positions. A handle (7) at the end of each arm may be formed from resilient or flexible material. In an alternative embodiment, a sucker may be provided on the end of an arm to allow attachment to the wall of a microwave oven.

The cover (3) is releasably secured to the bowl (1) by resilient clips (16).

Toothed racks (18) extend along the inner surfaces of the arms (6) and engage a toothed wheel (19) so that the arms move simultaneously in opposite directions when one of the handles is extended.

The lower portion (20) of the body (2) extends through an aperture (21) in the cover (3) and engages a lower cover plate (10) having a downwardly facing surface(14) from which the stirrers (8,9) extend downwardly into the bowl (1). A toothed orbital gear (11) provided on the lower surface of the cover (3) engages a planetary gear (12) so that the gear (12) rotates when the cover (3) is caused to rotate relative to the arms and body by rotation of the bowl on the microwave oven turntable. In an alternative embodiment the orbital gear may be provided on the upper surface of the cover (3). The gear ratio between the orbital and planetary gear may be 5:1 in order to provide an effective rate of stirring and mixing during rotation without causing spillage.

A fixed stirrer (8) consists of a mounting for attachment to the surface (14) of lower cover plate (10) and a downwardly extending laminar member having a resilient blade (13) with an outer edge (24) shaped to contact the inner surface of the bowl (1) in use. The angular disposition of the fixed stirrer (8) in relation to the body (2) remains unchanged as the bowl (1) and cover (3) rotate.

A rotatable stirrer (9) is coupled to and extends downwardly from the planetary gear (12) and cover plate(10). The rotatable stirrer (9) comprises a mounting for attachment to the gear (12) and a downwardly extending laminar member. The angular disposition between the stirrer axis of the rotatable stirrer (9) and planetary gear (12) in relation to the fixed stirrer (8) is selected so that one or both edges (22) pass adjacent the fixed stirrer (8) with sufficient clearance being provided to prevent obstruction by solid pieces of food.

The rotatable stirrer is located behind the fixed stirrer in relation to the direction of rotation of the fixed stirrer relative to the bowl so that foodstuff flowing around the fixed stirrer encounters a zone of mixing.

The axis of the planetary gear (12) and rotatable stirrer (9) is located at a radius from the central axis of the mixer intermediate the radial distances of the inner edge (23) and outer edge (24) of the fixed stirrer (8) from the central mixer axis.

While the present invention has been illustrated and described with respect to a particular embodiment thereof, it should be appreciated by those of ordinary skill in the art that various modifications to this invention may be made without departing from the spirit and scope of the present.

What is claimed is:

1. A microwave oven food mixer comprising:
a body;
a plurality of arms extending outwardly from the body;
the length of each arm being adjustable between a retracted position and an extended position;
the body including a drive mechanism;
the body and arms being configured so that the body may be engaged to the lip of a culinary vessel disposed on a turntable of a microwave oven, with the arms extended to engage walls of the oven;
a mixing arrangement extending downwardly from the body and arranged to be located in said vessel in use;
wherein the mixing arrangement includes a fixed stirrer and a rotatable stirrer;
the fixed stirrer being secured to the body and being arranged to pass adjacent an inner wall of the vessel;
the rotatable stirrer being connected to the drive mechanism and arranged so that rotation of the vessel on a turntable in use with the arms engaging walls of the oven causes rotation of the rotatable stirrer.

2. The mixer as claimed in claim 1 wherein the fixed stirrer is a laminar member.

3. The mixer as claimed in claim 1 wherein the fixed stirrer extends radially from an inner location adjacent the axis of the mixer or spaced from the axis of the mixer to an outer location adjacent an interior wall of the vessel.

4. The mixer as claimed in claim 1 wherein the rotatable stirrer comprises a laminar member arranged to rotate about a stirrer axis.

5. The mixer as claimed in claim 4 wherein the stirrer axis is located at a distance from the mixer axis equal to a distance between the radii of the inner and outer locations of the fixed stirrer.

6. The mixer as claimed in claim 1 wherein the rotatable stirrer is located at an angular disposition relative to the fixed stirrer of 10° to 130°.

7. The mixer as claimed in claim 6 wherein the rotatable stirrer is located at an angular disposition relative to the fixed stirrer of 45° to 120°, preferably about 90°.

8. The mixer as claimed in claim 1 wherein the location of the axis of the rotatable stirrer and angular location of the rotatable stirrer relative to the fixed stirrer are selected so that an edge of the rotatable stirrer passes adjacent to the surface of the fixed stirrer as the mixer rotates.

9. The mixer as claimed in claim 1 wherein the rotatable stirrer is located behind the fixed stirrer relative to the direction of flow of the foodstuff in use.

10. The mixer as claimed in claim 1 comprising a vessel engaging portion rotatably mounted on the body, the arms being mounted on the fixed body.

11. The mixer as claimed in claim 1 wherein the drive comprises a planetary gear arrangement.

12. The mixer as claimed in claim 11 wherein an orbital gear is provided on the rotatable vessel engaging portion, the orbital gear engaging a planetary gear connected to the rotatable stirrer.

13. The mixer as claimed in claim 12, wherein the gear ratio of the orbital and planetary gears is from 3:1 to 7:1, preferably 5:1.

14. The mixer as claimed in claim 1 wherein the arms are mounted in guides in the body and are movable between retracted and extended positions.

15. The mixer as claimed in claim 14 wherein each arm has a toothed rack, a gear being located within the body between the racks and engaging each rack so that the arms move simultaneously in opposite directions.

16. The kit comprising the mixer as claimed in claim 1, with one or more vessels.

17. The kit as claimed in claim 16 further comprising one or more fixed and rotatable stirrers.

18. A mixer substantially as hereinbefore described with reference to the accompanying drawings.

19. A kit substantially as hereinbefore described with reference to the accompanying drawings.
